(19) United States
(12) Patent Application Publication
(10) Pub. No.: US 2016/0140454 A1
(43) Pub. Date: May 19, 2016

(54) User Interest Learning through Hierarchical Interest Graphs

(71) Applicant: Adobe Systems Incorporated, San Jose, CA (US)

(72) Inventors: Shivani Gupta, Karnal (IN); Charanjit Singh Ghai, Nagar (IN); Gaurush Hiranandani, Jaipur (IN); Anshul Agrawal, Indore (IN)

(21) Appl. No.: 14/548,116

(22) Filed: Nov. 19, 2014

(51) Int. Cl. G06N 99/00; G06Q 50/00; G06N 5/02

(52) U.S. Cl. CPC G06N 99/005; G06N 5/022; G06Q 50/01

(57) ABSTRACT

User interest learning through hierarchical interest graph techniques are described. In one or more implementations, each of a plurality of categories in a directed hierarchical interest graph are assigned a distance value which represents a shortest distance in the directed hierarchical interest graph from a root category to the category. A list of keywords is formed from user data that denotes a corresponding said category and frequency of the category. A maximum of the frequencies amongst the plurality of categories is determined and a score is calculated for each of the keywords based on the frequency of the category, the maximum of the frequencies, and the distance value for the keyword. Increments of scores may be propagated from child categories to parent categories in the hierarchical interest graph such that greater weighting is given to child categories that are less abstract than parent categories in the directed graph. Further, the scores of the plurality of categories may be adjusted based on subsequent scores calculated from subsequent user data.

### BACKGROUND

The learning of a user's specific interests may be used to support ever increasing varieties of functionality. For example, knowledge of a user's interest may be utilized to provide targeted advertising that may be of interest to a user and thus have greater likelihood of success. Similarly, knowledge of a user's interests may be used to order search results, configure web pages, and so on.

Conventional techniques that are utilized to learn these interests typically rely on a strict hierarchy of categories that is performed by removing edges from cycles and also removing edges from less abstract categories to more abstract categories. This is typically performed to simplify a graph structure, but has a cost of loss of information from the graph. Further, conventional techniques typically rely on a raw frequency based model which may employ heuristics without logic and thus perform needless operations, such as to add a constant factor that may have little to no relevance. These techniques may also rely on sources of data that may have limited relevance to user likes and typically did not make temporal distinctions, e.g., between old and recent “likes.” Accordingly, these conventional techniques could be inaccurate and misleading.

### SUMMARY

User interest learning through hierarchical interest graph techniques are described. In one or more implementations, each of a plurality of categories in a directed hierarchical interest graph are assigned a distance value which represents a shortest distance in the directed hierarchical interest graph from a root category to the category. A list of keywords is formed from user data that denotes a corresponding said category and frequency of the category. A maximum of the frequencies amongst the plurality of categories is determined and a score is calculated for each of the keywords based on the frequency of the category, the maximum of the frequencies, and the distance value for the keyword. Increments of scores may be propagated from child categories to parent categories in the hierarchical interest graph such that greater weighting is given to child categories that are less abstract than parent categories in the directed graph. Further, the scores of the plurality of categories may be adjusted based on subsequent scores calculated from subsequent user data.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 is a flow diagram depicting a procedure in an example implementation in which a hierarchical interest graph is generated.

FIG. 3 depicts a system in an example implementation in which pre-processing is performed by a graph generation module of FIG. 1.

FIG. 4 depicts a system in an example implementation in which a hierarchical interest graph is generated.

FIG. 5 depicts an example of a directed graph.

FIG. 6 depicts a system in an example implementation in which scores of a plurality of categories of a hierarchical interest graph of FIG. 4 are adjusted based on subsequent scores calculated from subsequent user data.

FIG. 7 illustrates an example system including various components of an example device that can be implemented as any type of computing device as described and/or utilize with reference to FIGS. 1-6 to implement embodiments of the techniques described herein.

### DETAILED DESCRIPTION

### Overview

Conventional techniques used to determine interests of a user could have limited accuracy due to a variety of factors, such as due to removal of edges from cycles and less abstract categories, reliance on data having a dubious relationship with the user's interests, propagation techniques the caused a greater likelihood of abstract categories being output than less abstract categories, and so on.

Hierarchical interest graph techniques are described. In one or more implementations, techniques may be employed to generate a hierarchical interest graph that does not involve removal of edges either from cycles or from less abstract categories to more abstract categories so that the structural information contained in the graph is not lost. Further, the techniques may be configured to calculate higher scores for conceptually less abstract categories, since these categories may describe the specific interests of the user. Consider a text on “Australian Cricket” which when fed to the tool gives “Sports” and “Cricket” as relevant categories, the techniques may be used to give a higher score to “Cricket” than to “Sports” since “Cricket” is a more specific interest as compared to “Sports”.

Also, unlike conventional techniques, the techniques described herein may be performed without use of experimentally obtained heuristics for score propagation. For example, the techniques may take the structure of the graph and semantics of the hierarchy into account. For example, consider “Music” as a category and “Shopping” and “Arts” as two parents of this category in a directed graph, e.g., two “super categories.” Propagation of scores from “Music” may occur to both “Arts” and “Shopping”, however this propagation may be higher in “Arts” because of semantic similarity between “Arts” and “Music” than between “Music” and “Shopping.”

The propagation techniques described herein may also consider a length of a path in a directed graph that is taken for propagation. The score propagation, for instance, may be made dependent on a depth of the parent (e.g., “super”) category and the depth of the child (e.g., base) category, e.g., number of “edges” or hierarchical levels. For example, “Cricket” may be identified as a keyword that has “Sports” and “Television” as “direct” parents, while “Television” is subcategory of “Entertainment,” i.e., is a child of “Entertainment.” In this case, propagation from “Cricket” to “Sports” may include a larger increment that an increment propagated to “Entertainment.” This is performed because propagation from “Cricket” to “Entertainment” is done via “Television” and thus is a longer path as compared to “Sports” in the directed graph based on number of edges in the directed graph.

Further, the techniques described herein may take into account temporal considerations, such as recent versus past interests. Thus, the hierarchical interest graph techniques may distinguish between new and previous interests and thus have increased accuracy. Further, these techniques may also consider semantics of the relationship between the parent and child categories, which is not considered in conventional solutions as described above.

As also described above, the techniques may be used to give higher scores to more specific categories in contrast to other approaches which generated scores based solely on frequency due to which only abstract interests of the user were revealed since the score of abstract categories is typically increased to have high values due to conventional propagation techniques. Further, these techniques may leverage data having increased relevance, such as “likes” in a social network service (e.g., Facebook®) and user identifiers of accounts being followed, e.g., via Twitter®. Further discussion of these and other examples may be found in relation to the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

Example Environment

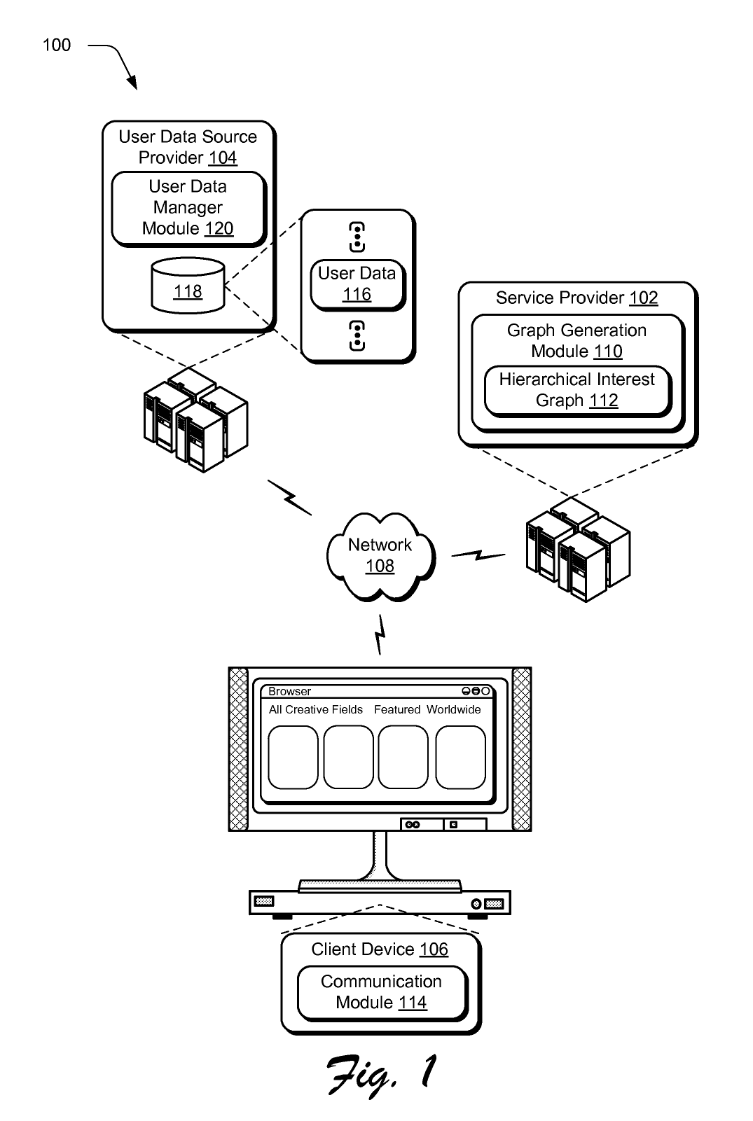

FIG. 1 is an illustration of an environment 100 in an example implementation that is operable to employ techniques described herein. The illustrated environment 100 includes a service provider 102, a user data source provider 106, and a client device 106 that are communicatively coupled, one to another, via a network 108. Although illustrated separately, functionality represented by the service provider 102 and the user data source provider 104 may also be combined into a single entity, may be further divided across other entities that are communicatively coupled via the network 108, and so on.

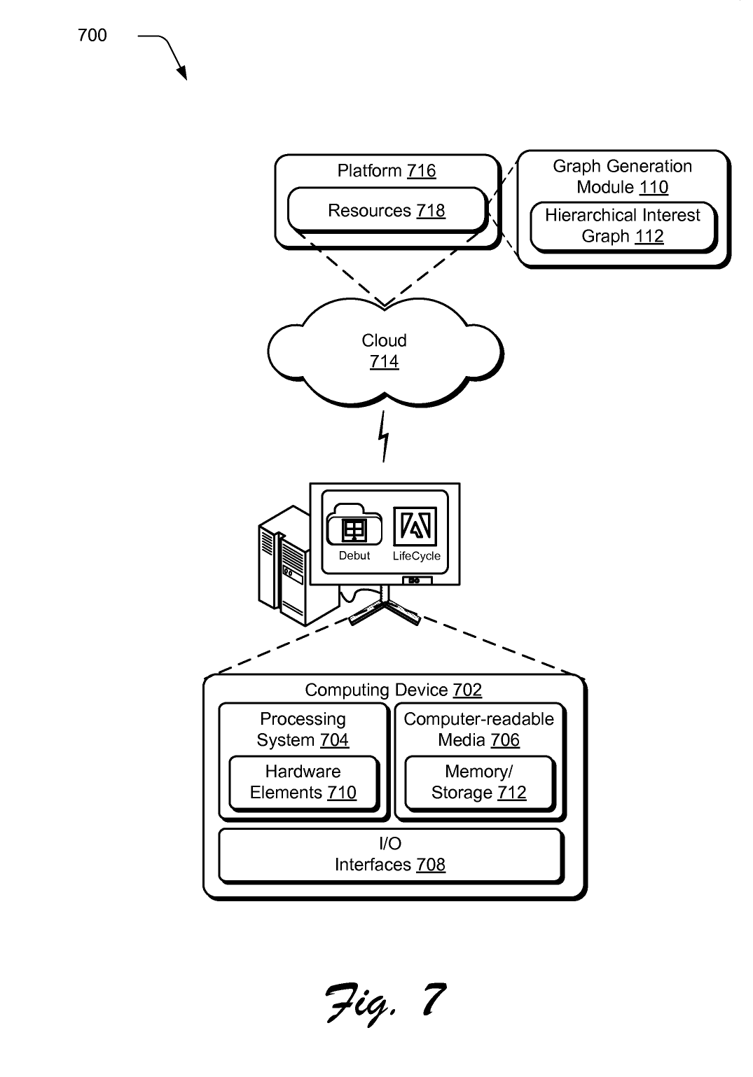

Computing devices that are used to implement the service provider 102, the user data source provider 104, and the client device 106 may be configured in a variety of ways. Computing devices, for instance, may be configured as a desktop computer, a laptop computer, a mobile device (e.g., assuming a handheld configuration such as a tablet or mobile phone), and so forth. Thus, computing devices may range from full resource devices with substantial memory and processor resources (e.g., personal computers, game consoles) to a low-resource device with limited memory and/or processing resources (e.g., mobile devices). Additionally, although a single computing device is shown in some instances, computing devices may be representative of a plurality of different devices, such as multiple servers utilized by a business to perform operations “over the cloud” as shown for the content creation service 102 and the content deployment service 104, further discussion of which may be found in relation to FIG. 7.

The service provider 102 is illustrated as including a graph generation module 110. The graph generation module 110 is representative of functionality to generate a directed graph, such as a hierarchical interest graph 112, which is configured to identify likely interests of a user. A user, for instance, may interact with a client device 106 having a communication module 114 that is configured to support communication via a network 108. The communication module 114 may be configured as a browser, a network-enabled application, third-part plug in, and so on.

As part of the communication supported by the communication module 114, user data 116 may be generated that describes user interaction with one or more web services, which is illustrated as stored in storage 118. As user interaction may take a variety of different forms, so too may the user data 116 take a variety of forms to describe this interaction. The user data source provider 104, for instance, may be included as part of a social network service, such as Facebook®, Twitter®, LinkedIn®, Behance®, and so forth. A user data manager module 120 may be configured to monitor this interaction and generate user data 116 that describes the monitored user interaction, which may indicate content with which the user has interacted, likes, dislikes, follows of user accounts, content that is uploaded and/or downloaded by a user, and so on.

The user data 116 may then be exposed by the user data source provider 104 for access by the graph generation module 110 of the service provider 102 via the network 108, e.g., via one or more application programming interfaces. The graph generation module 110 may then employ this user data 116 to construct and leverage a hierarchical interest graph 112 that may be utilized to determine interests of the users as indicated by the user data 116. The hierarchical interest graph 112 includes a plurality of categories as nodes that have hierarchical relationships, e.g., parent/child relationships. A variety of different techniques may be employed by the graph generation module 110 in the creation of the hierarchical interest graph 112.

The graph generation module 110, for instance, may employ techniques that give emphasis on less abstract categories and propagate scores using greedy propagation while giving increased weights to recent interests as well. This may be used to learn the interests of a user in the form of keywords and associated scores. Additionally, greedy propagation may be used to give greater weights to recent interests as well as less abstract interests as further described below. For example, the user data 116 may describe expressed approval of a user, e.g., “likes” in a social network service, particular accounts in a social network service that are followed by a user, and so on.

The graph generation module 110 may be configured to generate the hierarchical interest graph 112 from the user data 116 without removing edges either from cycles or from less abstract categories to more abstract categories so that the structural information contained in the graph is not lost.

Additionally, the graph generation module 110 may be configured to generate the hierarchical interest graph 112 to generate higher scores to the conceptually less abstract categories since these less abstract categories describe the specific interests of the user. For example, consider a text on “Australian Cricket” which includes “Sports” and “Cricket” as relevant categories. The graphic generation module 110 may give a higher score to “Cricket” than to “Sports” since “Cricket” is a more specific interest as compared to “Sports”.

In one or more implementations, the graph generation module 110 may also be configured to avoid use of experimentally obtained heuristics for score propagation, but rather take the structure of the graph and semantics of the hierarchy into account. As described above, for instance, consider “Music” as a category and “Shopping” and “Arts” as two parents of this category in a directed graph, e.g., two “super categories.” Propagation of scores from “Music” may occur to both “Arts” and “Shopping,” however this propagation may be higher in “Arts” because of semantic similarity between “Arts” and “Music” than between “Music” and “Shopping.”

Additionally, the graph generation module 110 may take into account a length of a path in a directed graph that is taken for propagation. Score propagation, for instance, may be made dependent on a depth of the parent (e.g., “super”) category and the depth of the child (e.g., base) category, e.g., a number of “edges” or hierarchical levels. For example, “Cricket” may be identified as a keyword that has “Sports” and “Television” as “direct” parents, while “Television” is subcategory of “Entertainment,” i.e., is a child of “Entertainment.” In this case, propagation from “Cricket” to “Sports” may include a larger increment that an increment propagated to “Entertainment.” This is performed because propagation from “Cricket” to “Entertainment” is done via “Television” and thus is a longer path as compared to “Sports” in the directed graph based on number of edges in the directed graph. Further, the graph generation module 110 may take recent interests into account as well.

Thus, the graph generation module 110 may be used to determine the interests of a user which may include distinguishing between new and previous interests. Further, the graph generation module 110 may considers the semantics of the relationship between the parent and child categories, which is not performed in conventional techniques. Additionally, the graph generation module 110 may give higher base scores to more specific categories in contrast to conventional approaches which generated scores based solely on frequency, which caused abstract interests of the user to be given greater weight since the score of abstract categories is unnaturally increased due to conventional propagation. Also, the graph generation module 110 may consider the description of Facebook pages liked by the user and names of the famous personalities the user is following on Twitter in contrast to other solutions that relied upon communications formed by the user (e.g., Tweets) which may not reflect the actual interests of the user, although other examples are also contemplated in which these may be leveraged apart from or in addition to the “likes” and “follows.” The hierarchical interest graph 112 may then be exposed to support a variety of functionality, such as to rank images or other results in a search query, target advertisements, configured webpages, and so on as further described in relation to the following section.

Hierarchical Interest Graphs

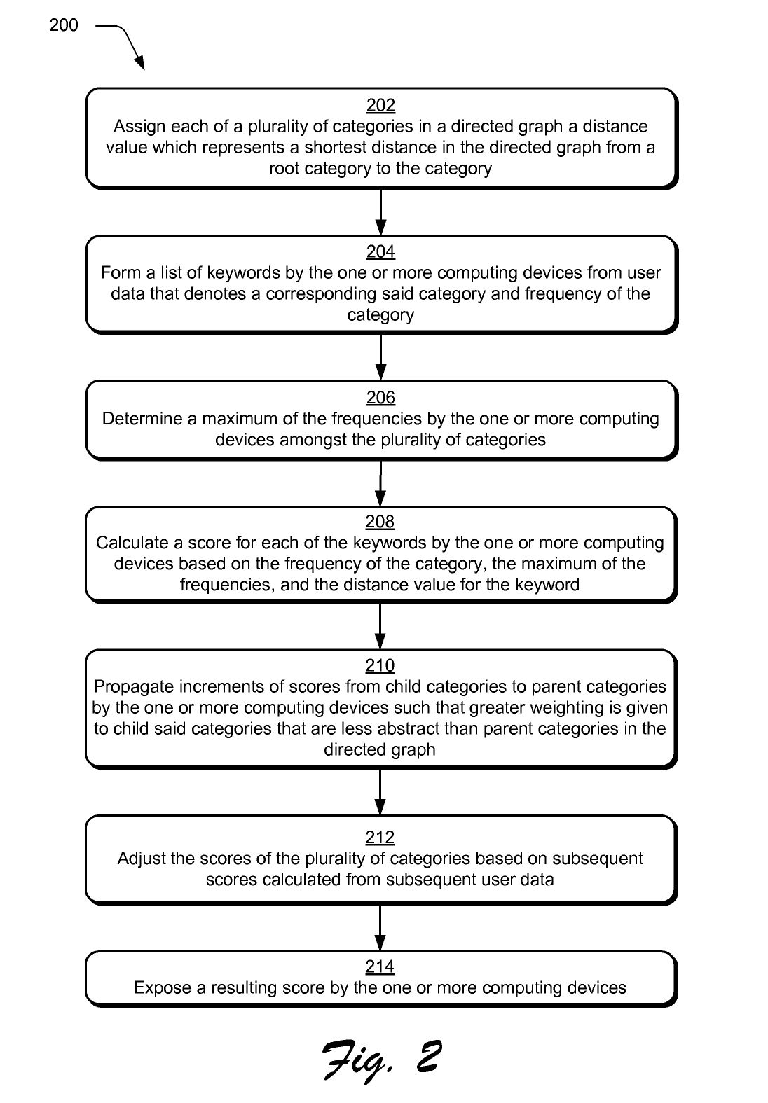

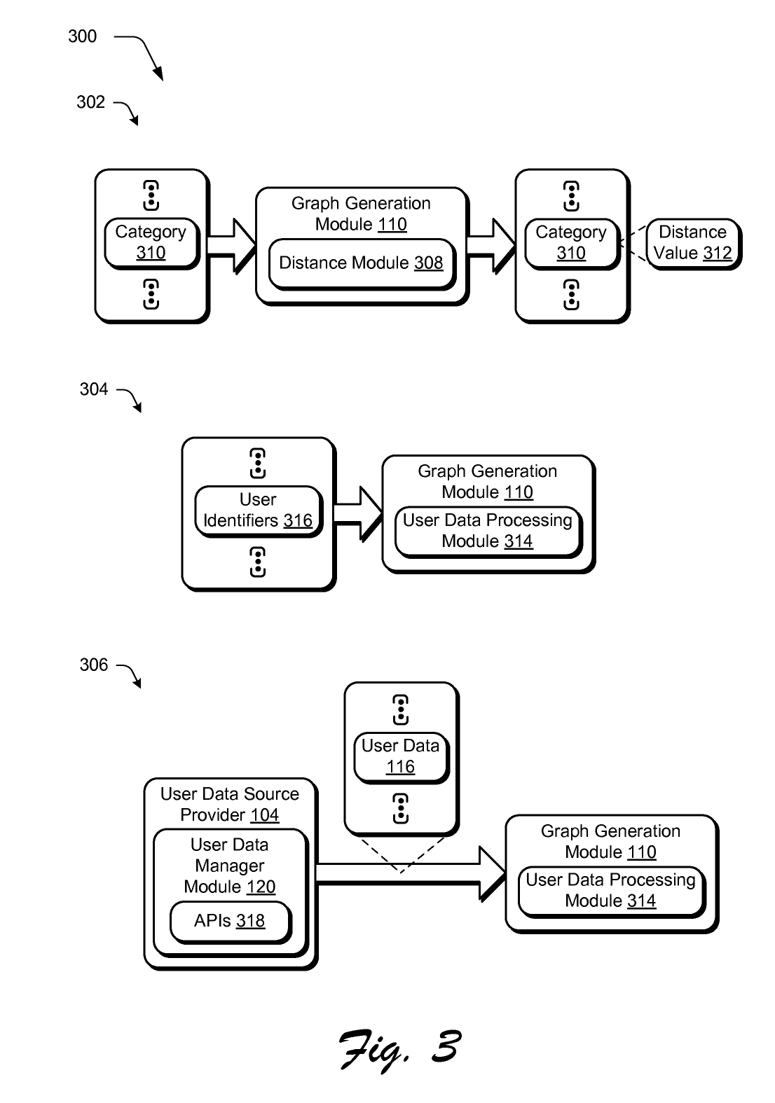

FIG. 2 depicts a procedure 200 in an example implementation in which a hierarchical interest graph 112 is generated. The following discussion techniques that may be implemented utilizing the previously described systems and devices. As such, aspects of the procedure may be implemented in hardware, firmware, or software, or a combination thereof. The procedures are shown as a set of blocks that specify operations performed by one or more devices and are not necessarily limited to the orders shown for performing the operations by the respective blocks. The following discussion references the procedure 200 in FIG. 2 as well as systems 300-500 of FIGS. 3-5 interchangeably.

FIG. 3 depicts a system 300 in an example implementation in which pre-processing is performed by a graph generation module of FIG. 1. The system 300 is shown using first, second, and third stages 302, 304, 306 to perform the pre-processing. Each of a plurality of categories in a directed hierarchical interest graph are assigned a distance value which represents a shortest distance in the directed graph from a root category to the category (block 202). At the first stage 302, for instance, the graph generation module 110 includes a distance module 308. The distance module 308 is representative of functionality that is configured to assign each category 310 a distance value 312 that represents a shortest distance from a root category of a directed graph to the category 310. The directed graph, for instance, may include a plurality of categories assigned to nodes that are arranged in a hierarchical relationship, e.g., parent/child relationships. Accordingly, the distance module 308 may determine a minimum number of edges used to traverse between a particular category 310 and the root category of the directed graph to arrive at the distance value. These distance values 312 may be used by the graph generation module 110 as part of calculation of a score for the category 310 as further described below.

At the second stage 304, the graph generation module 110 includes a user data processing module 314 that is representative of functionality to obtain user identifiers 316 of users, for which, interests are to be determined. The user data processing module 314, for instance, may be configured to access application programming interfaces of a social network service (e.g., Facebook®, Twitter®) to obtain user identifiers (e.g., account identifiers, “handles) of the users that are to be processed to determine likely interests. In another example, this information may be input manually.

At the third stage 306, the user data processing module 314 of the graph generation module 110 employs the user identifiers 316 obtained in the second stage 304 to obtain user data 116. The user data processing module 314, for instance, may access APIs 318 of a user data manager module 120 of a user data source provider 104 via the network 108 of FIG. 1. The APIs 318 may be configured to expose user data 116 that corresponds to the user identifier 316, e.g., users of a social network service. For example, for a Facebook® API the user data processing module 314 may obtain user data 116 that includes a “description”, “categories”, “about,” and so on of the pages of the social network service “liked” by the user. In another example, the Twitter® API may be used to get account identifiers of accounts that are being followed by the user on the social network service. The user data 116 may then be used to generate a hierarchical interest graph 112, further discussion of which may be found in the following and is shown in a corresponding figure.

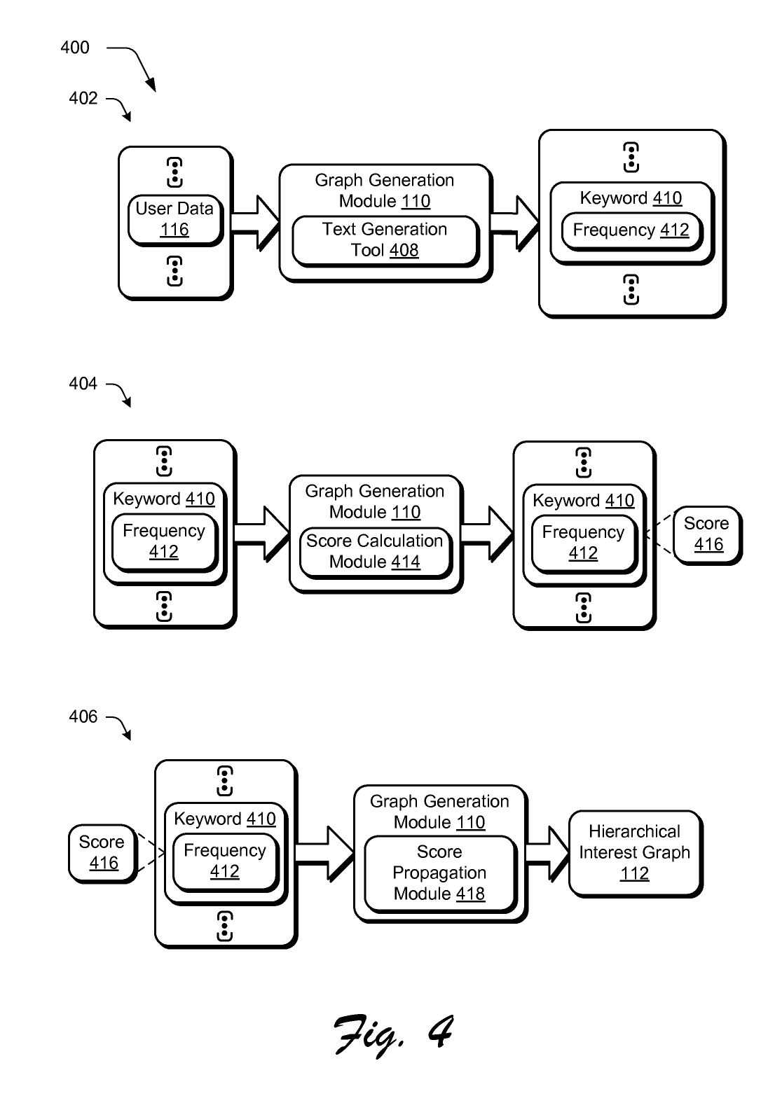

FIG. 4 depicts a system 400 in an example implementation in which a hierarchical interest graph 112 is generated. The system 400 includes first, second, and third stages 402, 404, 406. A list of keywords is formed from user data that denotes a corresponding category and frequency of the category (block 204). At the first stage 402, for instance, the graph generation module 110 includes a text generation tool 408 that is representative of functionality to output relevant categories or words from text received as an input.

As illustrated, the text generation tool 408 may receive user data 116 as an input and return as an output a list of keywords 410 “K” and a frequency 412 of respective keywords 410 in the user data 116. Thus each entry of the list of keywords 410 “K” is of the form (kᵢ, fᵢ) where “kᵢ” is a category and “fᵢ” is the frequency of this category.

A determination is then made as to a maximum of the frequencies amongst the plurality of categories (block 206). For example, let “fₘₐₓ” be the maximum of frequencies amongst each of the categories in the directed graph.

A score is calculated for each of the keywords based on the frequency of the category, the maximum of the frequencies, and the distance value for the keyword (block 208). As shown in the second stage 404, for instance, the graph generation module 110 may include a score calculate module 414. The score calculation module 414 is representation of functionality to assign a score 416 (e.g., base score “S_{b}”) to each of the matched keyword 410, which may be performed using the following expression:

$${S}_{b} = \frac{{f}_{i}}{{f}_{max}} {}_{}^{*}{d}{}_{i}^{}$$

where “fᵢ” is a frequency of the category “i,” “fₘₐₓ” is the maximum Frequency, and “dᵢ” is the distance of the category “i” from the root category as assigned during the pre-processing of FIG. 3. The frequency of “ith” category is divided by the maximum frequency to determine a relative interest of the user in this category with respect to a category of maximum interest (frequency). Further, the frequency score is multiplied by the distance of the category from the root. This is performed such that if a more specific category is returned as a relevant category, then this category is calculated to have a higher base score so that the specific interests of the user may be determined. In this way, less abstract categories may be given greater weight.

Increments of scores are propagated from child categories to parent categories such that greater weighting is given to child categories that are less abstract than parent categories in the directed graph (block 210). As shown at the third stage 406, for instance, the graph generation module 110 includes a score propagation module 418. The score propagation module 418 is representative of functionality to propagate increments of scores 416 “upward” in the directed graph through the hierarchy toward a root category of the graph as part of generating the hierarchical interest graph 112.

For example, for each keyword 410, frequency 412 tuple “(k, f)” in the list of keywords “K,” a score 416 associated with the keyword 410 is propagated to a one or more parent categories (e.g., super categories) as follows:
Let “NU” denote a number of parents of the category “k”;
Let “R” denote a semantic similarity between the category “k” and its parent “p” as calculated by a tool that generates a similarity value between two categories, e.g., which gives a higher similarity index value for “Cricket” and “Sports” as compared to similarity index value for “Cricket” and “News”;
Let “dc” denote the distance of a child “(k)” from a root category and “dp” denote the distance of a parent from the root category;
Let “S_{b}^{k}” denote a score (e.g., base score) of the category “k”; and
Let “Sₚ^{k}” be the score assigned to parent “p” of category “k” (initially 0).

The size of increments of the score 416 that are propagated to other categories may be calculated as follows:

$$\begin{matrix}{S}_{p}^{k} = {S}_{p}^{k} + ( \frac{1}{N U} + R ) {}^{*} [ {2}^{dc - dp - 1} ] {}_{}^{*}{S}{}_{b}^{k} & ( 1 ) \\ {S}_{p}^{k} = {S}_{p}^{k} + ( \frac{1}{N U} + R ) {}^{*} [ {2}^{dc - dp - 1} ] {}_{}^{*}{S}{}_{incr}^{} & ( 2 )\end{matrix}$$

The formula (1) shows changes in score if the parent category is an immediate parent of category k. If the parent is rather just an ancestor of category “k” and not a direct (i.e., immediate) parent, then the change in score of parent is shown by formula (2).

Here “S_{incr}” is the increment in the score of the child in this propagation. Thus, if some score is propagated to any category it will further trigger score propagation to its parents and so on. A resulting (e.g., final) score may be calculated as a sum of the increments accumulated during propagation from each category of “K” and the base score for any category.

In the above formulas, the first part represents the weight of the edge from the child to the parent;

$$W = \frac{1}{N U} + R$$

The variable “NU” represents a number of parents of “k.” This is derived based on a structure of the directed graph such that the higher the number of parents, the lesser the structural relevance of any one particular parent to the child category “k.”

The second term “R” (in W) represents a semantic similarity of the parent and the child. As stated above, propagation from “Music” to “Arts” may be higher than propagation from “Music” to “Shopping”. Accordingly, the higher the semantic relevance, the greater the value of “R” and thus the higher the amount of propagation, i.e., the larger the increment.

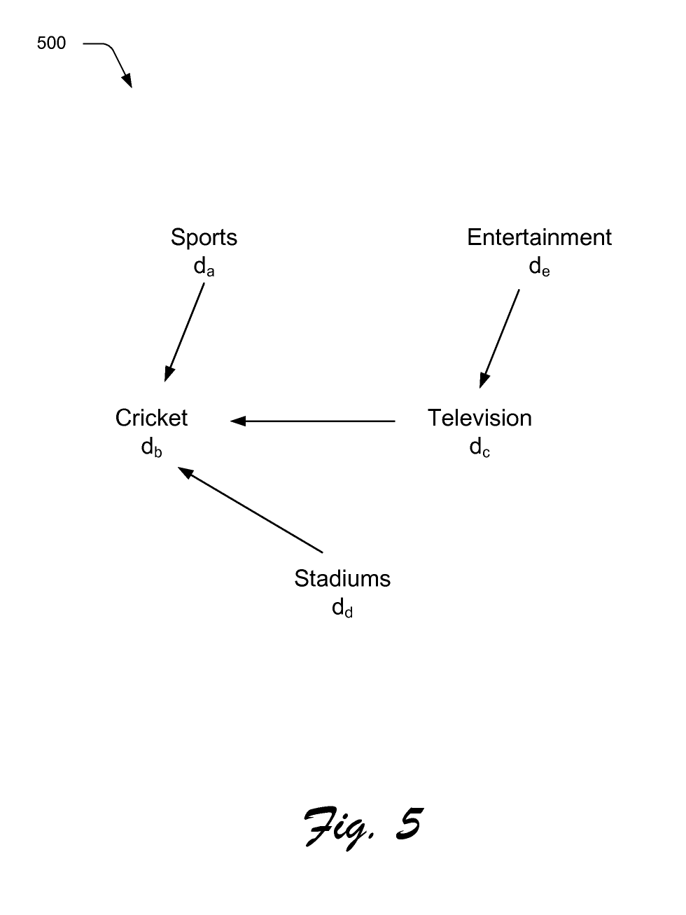

The second multiplier takes into account the length of the path taken for propagation. For example, consider an example directed graph 500 as shown in FIG. 5. In this directed graph 500, “Sports”, “Cricket”, “Stadiums”, “Television” and “Entertainment” are the categories in the directed graph 500. “Cricket” has three parents, which are illustrated as “Sports,” “Television,” and “Stadiums.” Let “di” represent a distance of category “i” from a root.

The relation between the distances is as follows:

dₑₙₜₑᵣₜₐᵢₙₘₑₙₜ=dₛₚₒᵣₜₛ<d_{cricket}=dₜₑₗₑᵥᵢₛᵢₒₙ<d_{stadiums}

For propagation from child “i” to parent “p” there are three cases:

dᵢ>dₚ (“Cricket”, “Sports”);

dᵢ<dₚ (“Cricket”, “Stadiums”); and

dᵢ=dₚ (“Cricket”, “Television”);

each of these are captured in the example.

As previously described, propagation performed by the score propagation module 418 of the graph generation module 110 may be configured to take the graph structure into account. In the present example, propagation to “Sports” is the “highest” (i.e., includes the largest increment), since it is both the conceptually less abstract category (i.e., greater distance from root) and is a direct parent of “Cricket.” “Television” is conceptually as abstract as “Cricket” but is a direct parent. So the propagation to “Television” is lower as compared to “Sports” in this example, and propagation to “Stadiums” (which is conceptually less abstract than Cricket though being a direct parent) is the lowest, i.e., includes the smallest increment.

As the minimum distance is defined, “d_{b}≦dₐ+1” (since there is already a path of distance “da+1” to B) and also in this case “d_{b}>dₐ, so d_{b}=dₐ+1,” the multiplier is “2^{di-dp-1}”. Thus, the multiplier for propagation to “Sports” to determine a size of the increment is “1” and hence propagation to “Sports” is proportional to the edge weight, which is the general case.

Next, the multiplier for “Television” is one-half, which is used to form the increment. For example, since “Television” causes propagation of a score to “Entertainment” which is a longer path, the amount propagated by the increment is lower. Further, the multiplier for “Stadiums” is smaller than half, which again is as expected since the propagation from “Stadiums” to other categories is to involve even smaller increments based on the longer distance in the directed graph, e.g., a greater number of edges.

It may be noted that in this example a part of “increment of score” is further propagated and not a part of “entire score” of the child such that if “C” is a category with some midway entire score “and” and some additional score “Sₚ” is propagated to it during the score propagation of any of the categories, then:

$$( \frac{1}{N U} + R ) {}^{*} [ {2}^{dc - dp - 1} ] {}_{}^{*}{S}{}_{p}^{}$$

is propagated to its' parents in this propagation and not

$$( \frac{1}{N U} + R ) {}^{*} [ {2}^{dc - dp - 1} ] {}_{}^{*}{S}{}_{c}^{} .$$

Another aspect to score propagation involves whether a plurality of paths are available between parent and child categories. In such an instance, the path along which the distance between the parent and child categories is minimized may be chosen for propagation since an edge represents parent/child relationship and thus the smaller is the number of edges, the smaller the number of containment relationships and the stronger the relation between the entities.

Regarding cycles, if there are cycles in directed graph then scores may propagate infinitely using conventional techniques. However, in one or more implementations, scores are propagated a single time to a category along the shortest path. This may be referred to as greedy propagation.

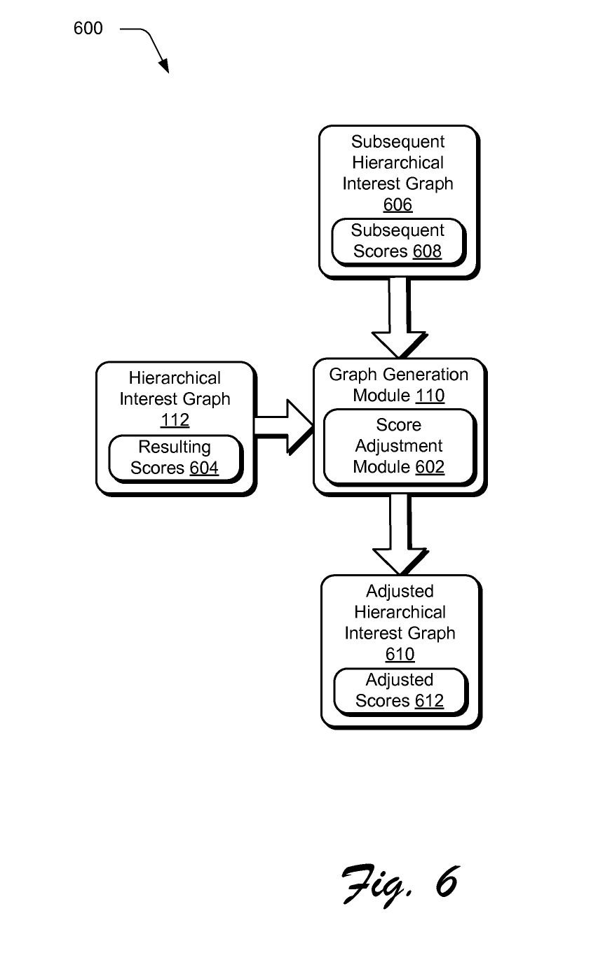

FIG. 6 depicts a system 600 in an example implementation in which scores of the plurality of categories of the hierarchical interest graph 112 of FIG. 4 are adjusted based on subsequent score calculated from subsequent user data. The scores of the plurality of categories are adjusted based on subsequent scores calculated from subsequent user data (block 212). As shown in the example system 600, the graph generation module 110 may include a score adjustment module 602 that is representative of functionality to adjust resulting scores 604 in the hierarchical interest graph 112. The resulting score 604 of the hierarchical interest graph 112 may include base scores resulting from the calculating (e.g., block 208) and/or propagation of increments (e.g., block 210) that is calculated from user data 116.

The graph generation module 110 may also receive subsequent user data (e.g., that is generated after the user data 116) and perform similar techniques to generate a subsequent hierarchical interest graph 606 having subsequent scores 608, e.g., recent “likes,” “follows,” and so on. The subsequent scores 608 may then be used by the score adjustment module 602 to adjust the resulting scores 604 of the hierarchical interest graph 112 to form an adjusted hierarchical interest graph 610 having adjust scores 612. This may be performed in a variety of ways.

For example, the resulting scores 604 (base score+propagated score) assigned to the categories may be calculated based on the previously known likings and followings of the person (e.g. “P” and “F”). These scores may be denoted for category “c” as “(S_{c})ₚᵣₑₛₑₙₜ=Present Score of Category p.”

When the user's interests are calculated again, user data 116 such as a set of pages liked by a user “NP” as well as accounts a user follows “NF” may be considered as before. Accordingly, the same technique may be used to calculate subsequent scores 608, but is limited to subsequent user date, e.g., the new pages and new followings. These scores for category “c” may be denoted as “(S_{c})_{new}=New Score of Category c.”

An adjusted score 612 may then be assigned to each category as a linear combination of “(S_{c})ₚᵣₑₛₑₙₜ” and “(S_{c})_{new}”, e.g.:

(S_{c})_{final}=α(S_{c})ₚᵣₑₛₑₙₜ+(1−α)(S_{c})_{new}

where

$$“ α = \frac{1}{{2}^{{d}_{c}}} ”$$

and “dc” is equal to a distance of category “c” from a root category as described above.

Thus, in this example the subsequent scores 608 are given at least half weightage as compared to the resulting scores 604 (i.e., “present” scores) since the subsequent scores 608 depict the recent activity of the user. Also, the subsequent scores 608 are calculated solely from subsequent user data in this example. In one or more implementations, this information may be smaller as compared to an entirety of the information considered for the resulting scores, e.g., “P” and “F.”

Additionally, the generic interests of a user may degrade slowly as compared to specific interests. For example, if a person is interested in sports then this interest in sports (e.g., distance from root is one) may degrade slowly and thus “α=1−α=½.” Further the factor for the subsequent scores 608 in case of more specific categories may be significantly higher than the factor for previous score (e.g., the resulting scores 604) since a more specific interest may have increased vulnerability to changes in recent likings. For example, a user that is quite interested in sports is unlikely to change that interest over years, but a specific interest may change. The user, for instance, may get more interested in soccer during a televised tournament and in basketball during a basketball season. Hence, as the graph generation module 110 goes deeper into the specific interests of the user, the module may give greater weights to subsequent scores 608 as compared to resulting (e.g., present) score of a current hierarchical interest graph 112. A variety of other examples are also contemplated without departing from the spirit and scope thereof.

Example System and Device

FIG. 7 illustrates an example system generally at 700 that includes an example computing device 702 that is representative of one or more computing systems and/or devices that may implement the various techniques described herein. This is illustrated through inclusion of the graph generation module 110 and hierarchical interest graph 112. The computing device 702 may be, for example, a server of a service provider, a device associated with a client (e.g., a client device), an on-chip system, and/or any other suitable computing device or computing system.

The example computing device 702 as illustrated includes a processing system 704, one or more computer-readable media 706, and one or more I/O interface 708 that are communicatively coupled, one to another. Although not shown, the computing device 702 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 704 is representative of functionality to perform one or more operations using hardware. Accordingly, the processing system 704 is illustrated as including hardware element 710 that may be configured as processors, functional blocks, and so forth. This may include implementation in hardware as an application specific integrated circuit or other logic device formed using one or more semiconductors. The hardware elements 710 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 706 is illustrated as including memory/storage 712. The memory/storage 712 represents memory/storage capacity associated with one or more computer-readable media. The memory/storage component 712 may include volatile media (such as random access memory (RAM)) and/or nonvolatile media (such as read only memory (ROM), Flash memory, optical disks, magnetic disks, and so forth). The memory/storage component 712 may include fixed media (e.g., RAM, ROM, a fixed hard drive, and so on) as well as removable media (e.g., Flash memory, a removable hard drive, an optical disc, and so forth). The computer-readable media 706 may be configured in a variety of other ways as further described below.

Input/output interface(s) 708 are representative of functionality to allow a user to enter commands and information to computing device 702, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 702 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 702. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 702, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 710 and computer-readable media 706 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 710. The computing device 702 may be configured to implement particular instructions and/or functions corresponding to the software and/or hardware modules. Accordingly, implementation of a module that is executable by the computing device 702 as software may be achieved at least partially in hardware, e.g., through use of computer-readable storage media and/or hardware elements 710 of the processing system 704. The instructions and/or functions may be executable/operable by one or more articles of manufacture (for example, one or more computing devices 702 and/or processing systems 704) to implement techniques, modules, and examples described herein.

The techniques described herein may be supported by various configurations of the computing device 702 and are not limited to the specific examples of the techniques described herein. This functionality may also be implemented all or in part through use of a distributed system, such as over a “cloud” 714 via a platform 716 as described below.

The cloud 714 includes and/or is representative of a platform 716 for resources 718. The platform 716 abstracts underlying functionality of hardware (e.g., servers) and software resources of the cloud 714. The resources 718 may include applications and/or data that can be utilized while computer processing is executed on servers that are remote from the computing device 702. Resources 718 can also include services provided over the Internet and/or through a subscriber network, such as a cellular or Wi-Fi network.

The platform 716 may abstract resources and functions to connect the computing device 702 with other computing devices. The platform 716 may also serve to abstract scaling of resources to provide a corresponding level of scale to encountered demand for the resources 718 that are implemented via the platform 716. Accordingly, in an interconnected device embodiment, implementation of functionality described herein may be distributed throughout the system 700. For example, the functionality may be implemented in part on the computing device 702 as well as via the platform 716 that abstracts the functionality of the cloud 714.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
assigning each of a plurality of categories in a directed hierarchical interest graph a distance value that represents a shortest distance in the directed hierarchical interest graph from a root said category to the category;
forming a list of keywords by the one or more computing devices from user data that denotes a corresponding said category and frequency of the category;
calculating a score for each of the keywords by the one or more computing devices based on the frequency of the category, a maximum of the frequencies amongst the plurality of categories, and the distance value for the keyword;
propagating increments of scores through the directed hierarchical interest graph from child said categories to parent said categories by the one or more computing devices such that greater weighting is given to child said categories that are less abstract than parent said categories in the directed hierarchical interest graph; and
outputting a resulting score by the one or more computing devices based at least in part on the calculating and the propagating.

2. A method as described in claim 1, wherein the propagating of the increments is performed for a plurality of said categories disposed in a plurality of levels in the directed hierarchical interest graph.

3. A method as described in claim 1, wherein the increments are based at least in part on a number of the parent said categories.

4. A method as described in claim 1, wherein the increments are based at least in part on semantic similarity of the parent said category and the child said category.

5. A method as described in claim 1, wherein the increments are based at least in part on a path taken in the directed hierarchical interest graph for the propagating.

6. A method as described in claim 1, further comprising determining there are a plurality of paths in the directed hierarchical interest graph between the parent and child said categories and the propagating is performed for the shortest one of the plurality of paths based on a number of edges involved in the plurality of paths, one to another.

7. A method as described in claim 1, further comprising adjusting the scores of the plurality of categories based on subsequent said scores calculated from subsequent user data and wherein the exposing is performed based at least in part on the calculating, the propagating, and the adjusting.

8. A method as described in claim 1, further comprising obtaining the user data from one or more social network services.

9. A method as described in claim 8, wherein the user data describes likes or followed user accounts in the one or more social network services.

10. A method implemented by one or more computing devices, the method comprising:
assigning each of a plurality of categories in a directed hierarchical interest graph a distance value that represents a shortest distance in the directed hierarchical interest graph from a root said category to the category;
forming a list of keywords from user data that denotes a corresponding one of the plurality of categories and frequency of the category;
determining a maximum of the frequencies amongst the plurality of categories;
calculating a score for each of the keywords based on the frequency of the category, the maximum of the frequencies, and the distance value for the keyword;
adjusting the scores of the plurality of categories based on subsequent said scores calculated from subsequent user data; and
outputting a resulting score by the one or more computing devices based at least in part on the calculating and the adjusting.

11. A method as described in claim 10, wherein the adjusting is performed as a linear combination of the calculated score of the user data and the subsequent said scores calculated from the subsequent user data.

12. A method as described in claim 11, wherein the resulting score from the adjusting is based at least in part on the distance.

13. A method as described in claim 10, further comprising obtaining the user data and the subsequent said user data from one or more social network services.

14. A method as described in claim 13, wherein the user data and the subsequent said user data describes likes or followed user accounts in the one or more social network services.

15. A system comprising:
a distance module implemented at least partially in hardware, the distance module configured to assign each of a plurality of categories in a directed hierarchical interest graph a distance value that represents a shortest distance in the directed hierarchical interest graph from a root said category to the category;
a text generation tool implemented at least partially in hardware, the text generation tool configured to form a list of keywords from user data that denotes a corresponding said category and frequency of the category and determine a maximum of the frequencies amongst the plurality of categories;
a score calculation module implemented at least partially in hardware, the score calculation module configured to calculate a score for each of the keywords based on the frequency of the category, the maximum of the frequencies, and the distance value for the keyword;
a score propagation module implemented at least partially in hardware, the score propagation module configured to propagate increments of scores from child said categories to parent said categories such that greater weighting is given to child said categories that are less abstract than parent said categories in the directed hierarchical interest graph; and
a score adjustment module implemented at least partially in hardware, the score adjustment configured to adjust the scores of the plurality of categories based on subsequent said scores calculated from subsequent user data.

16. A system as described in claim 15, wherein the score adjustment module performs the adjustment based at least in part on the distance value.

17. A system as described in claim 15, wherein the score adjustment module performs the adjustment as a linear combination of the calculated score of the user data and the subsequent said scores calculated from the subsequent user data.

18. A system as described in claim 15, wherein the increments are based at least in part on semantic similarity of the parent said category and the child said category.

19. A system as described in claim 15, wherein the increments are based at least in part on a path taken in the directed hierarchical interest graph for the propagating.

20. A system as described in claim 15, wherein the user data and the subsequent said user data describes likes or followed user accounts in the one or more social network services.
